(19) United States
(12) Patent Application Publication
(10) Pub. No.: US 2009/0106155 A1
(43) Pub. Date: Apr. 23, 2009

(54) System and Method for Archival of Electronic and Tangible Records

(76) Inventors: Marcos CASTELLANOS, Miramar, FL (US); Andrew BLANK, Miami, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/875,455

(22) Filed: Oct. 19, 2007

(51) Int. Cl. G06F 17/30; H04K 1/00

(52) U.S. Cl. 705/51; 705/7

(57) ABSTRACT

Systems and methods for record management are provided. The record management system may be used to track the location and ultimate disposition of tangible records and electronic record.

### FIELD OF THE INVENTION

The present invention generally relates to systems and methods for the archival of electronic and tangible records. More particularly, the present invention relates to systems and methods to index and retrieve both paper and electronic records.

### BACKGROUND OF THE INVENTION

Businesses accumulate records that pertain to their operation. For example, manufacturing reports, financial statements, quality assurance test results, and corporate governance records are just a few types of records that a business may generate over the course of time. Records may be kept in tangible form, for example in paper form, may be kept electronically, or may be kept in both tangible and electronic forms. Many of these records must be kept for a period of time, either as a requirement by government or other oversight organization, or because of legal requirements, and many requirements specify that records must be kept in either tangible or electronic form.

As a business grows, more of these records must be kept and warehoused. The indexing and organization of these records becomes increasingly difficult as the number of records increases. The inability to find and retrieve both paper and electronic records may present a hindrance to the business, both in terms of time lost finding the records or financial and legal penalties if the records cannot be found or cannot be found within an appropriate timeframe.

### SUMMARY OF THE INVENTION

Accordingly, various embodiments of the present invention directed to systems and methods for archival of electronic and tangible records are provided.

In one particular exemplary embodiment, the techniques may be realized as a method/apparatus for record management comprising of a associating one or more records with one or more items, associating one or more services with the one or more items, providing a virtual cart for the user to select one or more services for execution, and selecting one or more relevant services related to the one or more items for the user to choose.

In accordance with other aspects of this particular exemplary embodiment, the techniques may be realized as a method/apparatus for record management comprising associating one or more records with one or more items, associating one or more security profiles to each of the one or more items, wherein the one or more security profiles operate to restrict access to each of the one or more items to authorized users, and wherein the one or more security profiles may be bypassed by non-authorized users.

In accordance with other aspects of this particular exemplary embodiment, the techniques may be realized as a method/apparatus for record management comprising associating one or more records with one or more items, associating one or more services with the one or more items, providing one or more workspaces, the one or more workspaces associated with one or more users, associating one or more services with one or more workspaces, and allowing the one or more users to sort the one or more items associated with the one or more workspaces according to the preferences of the one or more users.

In accordance with other aspects of this particular exemplary embodiment, the techniques may be realized as a method/apparatus for record management comprising associating one or more alerts to one or more services, associating one or more records with one or more items, associating the one or more services with the one or more items, allowing one or more users to subscribe to one or more alerts, and informing one or more users subscribed to one or more alerts on the status of the one or more services associated with the one or more alerts.

Other embodiments are also within the scope of the invention.

### BRIEF DESCRIPTION OF THE DRAWINGS

The present invention, together with further objects and advantages, may best be understood by reference to the following description taken in conjunction with the accompanying drawings, in the several Figures of which like reference numerals identify like elements, and in which:

FIG. 1 is a network diagram showing a record management system in a multi-tenant mode according to at least one embodiment of the invention;

FIG. 1a is a system-level block diagram showing a record management system according to at least one embodiment of the invention;

FIG. 2 is a network diagram showing a record management system in a self-hosting environment according to at least one embodiment of the invention;

FIG. 3 is an exemplary diagram of a screen showing the security properties of an item according to at least one embodiment of the invention;

FIG. 4 is an exemplary diagram depicting possible security features according to at least one embodiment of the invention;

FIG. 5 is an exemplary diagram of a screen showing possible inputs for a new business unit according to at least one embodiment of the invention;

FIG. 6 is an exemplary diagram of sample business unit and elements comprising the business unit according to at least one embodiment of the invention;

FIG. 7 is an exemplary diagram of a screen showing a sample custom data entry template for an exemplary item type according to at least one embodiment of the invention;

FIG. 7a is an exemplary diagram of a screen showing exemplary locations for items according to at least one embodiment of the invention;

FIG. 7b is an exemplary diagram of a screen showing sequential bar code entry according to at least one embodiment of the invention;

FIG. 7c is an exemplary diagram of a screen showing potential code mask entries for an ad-hoc bar code entry form according to at least one embodiment of the invention;

FIG. 8 is a chart showing an exemplary layout of one possible format of item location areas according to at least one embodiment of the invention;

FIG. 9 is an exemplary diagram of a screen depicting holiday properties and date properties according to at least one embodiment of the invention;

FIG. 10 is an exemplary diagram of a sample workspace according to at least one embodiment of the invention;

FIG. 10a is an exemplary diagram showing an item status graph according to at least one embodiment of the invention;

FIG. 11 is an exemplary diagram showing possible services according to at least one embodiment of the invention;

FIG. 12 is a exemplary diagram of a screen showing a retention schedule according to at least one embodiment of the invention;

FIG. 13 is an exemplary diagram of a screen showing properties of the data entry template according to at least one embodiment of the invention;

FIG. 13a is an exemplary diagram of a screen showing a visibility dialog box according to at least one embodiments of the invention;

FIG. 14 is an exemplary diagram of a screen showing a sample template design form according to at least one embodiment of the invention;

FIG. 15 is an exemplary diagram of a screen showing a sample alert according to at least one embodiment of the invention; and

FIG. 16 is an exemplary flowchart of a record becoming associated with an item in a record management system according to at least one embodiment of the invention.

### DETAILED DESCRIPTION

The following description is intended to convey a thorough understanding of the embodiments described by providing a number of specific embodiments and details involving systems and methods for the archival of electronic and tangible records. It should be appreciated, however, that the present invention is not limited to these specific embodiments and details, which are exemplary only. It is further understood that one possessing ordinary skill in the art, in like of known systems and methods, would appreciate the use of the invention for its intended purposes and benefits in any number of alternative embodiments, depending on specific design and other needs.

A record management system may be used to create item records associated with electronic or tangible records. The items may be used to track the location, status, and ultimate disposition of the electronic or tangible records. The record management system may be able to create a structure to easily organize and recall the items. The record management system may also be able to create an organizational structure to identify the locations of tangible records. The record management system may implement time zone, date, time, holiday, and weight and measurement templates so that different users of the record management system may access data organized in a format according to their personal preferences. The record management system may implement security features so that only authorized users may have access to some or all of the records maintained in the record management system. The record management system may use one or more mobile devices to create new items in the record management system, track existing items in the record management system, or create, modify, or terminate services associated with one or more of the items.

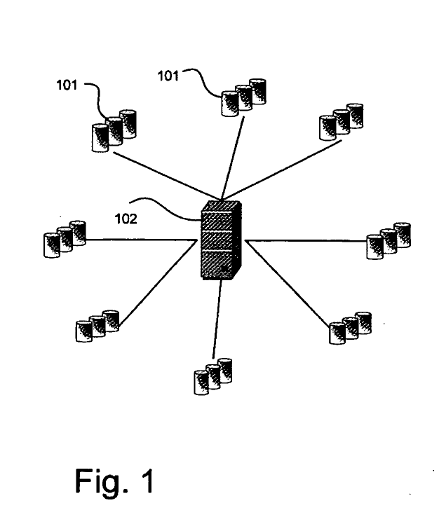

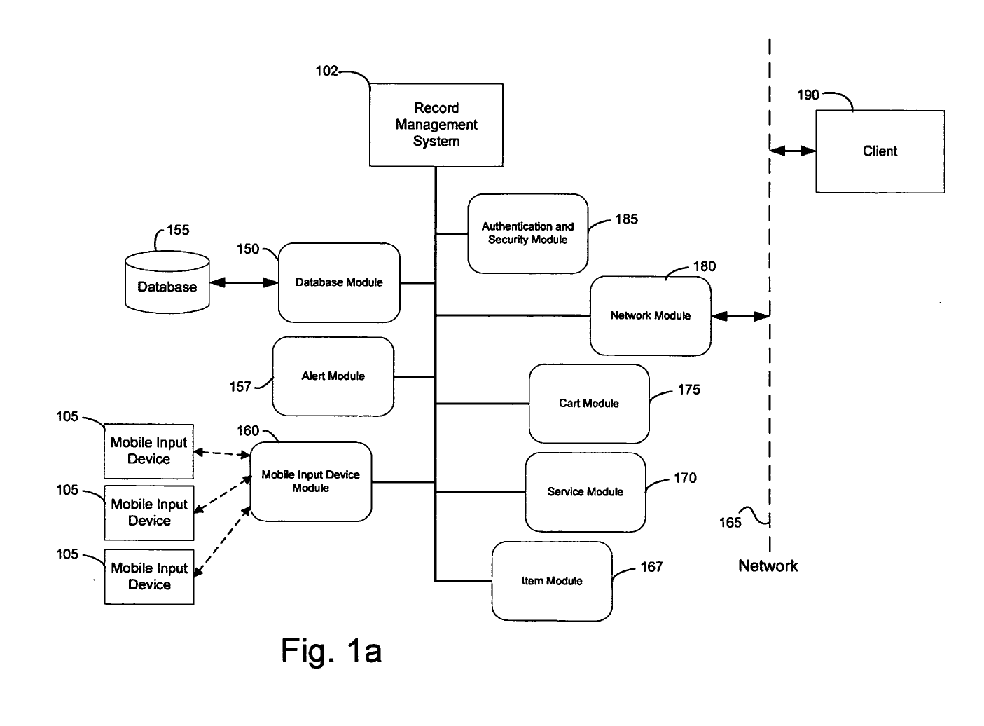

Turning to FIG. 1, a view of a record management system 102 in a multi-tenant mode is shown. The record management system 102 may be created so that it may house information related to one or more customers (collectively, 101) in a multi-tenant system. The record management system 102 may not be under the control of any of the customers, so that each of the one or more customers 101 may rent, lease, or buy capacity on the record management system 102. The record management system 102 may be located separately from the one or more customers 101, and may be accessible by the one or more customers over a network. It is possible that several instances of the record management system 102 may exist on one or more physical computers, and that each instance of the record management system 102 may be associated with one or more of the one or more customers 101. It is also possible that each instance of the record management system 102 may exist on a separate computer or computers, and that each instance of the record management system 102 may be associated with one or more of the one or more customers 101. Each of the one or more customers 101 may be able to edit or create information contained within their instance of the record management system 102, but may not be able to edit, create, or view information created by one of the other customers 101. The customers 101 may be responsible for updating and creating their own information in the record management system 102, and the owner of the record management system 102 may be responsible for maintenance to the record management system 102. For example, and without limitation, Company X may own computers which host one or more instances of the record management system 102. Companies Y and Z may rent, lease, or own their own instance of the record management system 102 from Company X. Company Y may create or edit information contained in the record management system 102 created for Company Y by Company X, but may not view or edit information contained in the record management system 102 created for Company Z by Company X. Company Z may be able to create or edit information contained in the record management system 102 created for Company Z by Company X, but may not view or edit information contained in the record management system 102 created for Company Y by Company X.

Turning now to FIG. 1a, an exemplary network diagram of a record management system 102 is shown. The record management system 102 may be generally operable to create and store item and item information. The record management system 102 may contain one or more of the following modules: an authentication and security module 185, a database module 150, an alert module 157, a network module 180, a cart module 175, a service module 170, an item module 167, and a mobile input device module 160. Depending on the scope or desires of the users and the owners of the record management system 102, the record management system 102 may have other modules as desired. The modules of the record management system 102 may be in communication with some or all of the other modules. The modules of the record management system 102 may be part of a single system, or the modules may be physically or logically separated. The record management system 102 may be operably connected to the network 165 so that the record management system 102 modules may be able to receive signals from the network 165 and generate signals to the network 165.

The authentication and security module 185 may be operable to receive authentication information from a client and may permit or deny access to the record management system 102. The authentication and security module 185 may also be operable to create and apply one or more security profiles to one or more items, or to other aspects of the record management system 102. The alert module 157 may be operable to monitor the status of the record management system and to generate and transmit alerts to users who have subscribed to receive one or more alerts. The alert module 157 may transmit alerts across the network, or may utilize another network to transmit alerts (e.g., a telephone network to transmit alerts across telephone circuits, or a wireless network to transmit alerts). The network module 180 may be operable to communicate with one or more networks 165, and may be operable to send signals to other devices connected to the network 165, or to receive signals from other devices connected to the network 165. The mobile input device module 160 may communicate with one or more mobile input devices 105, and may send information from the record management system 102 to one or more of the mobile input devices 105, or may accept information from one or more of the mobile input device 105 and send it to the record management system 102. The one or more mobile input devices 105 may authenticate to the system via the authentication module 185. The database module 150 may be in communication with one or more databases 155, and may be operable to store or recall information from or to the one or more databases 155 relating to items or other data of the record management system 102. The one or more databases 155 may be operably connected to the database module 150 or the record management system 102, or may be operably connected to the network 165. The item module 167 may be operable to create and store information regarding item types, or may be operable to display item templates or item records to the user across the network 165. The service module 170 may be operable to recall one or more lists of services from the database 155. The cart module 175 may be operable to associate one or more services and/or one or more services with one or more items. A user may interact with a client 190 in order to create, manipulate, or delete data within the record management system 102.

A network 165 may include, but is not limited to: e.g., a wide area network (WAN), a local area network (LAN), a global network such as the Internet, a telephone network such as a public switch telephone network, a wireless communication network, a cellular network, an intranet, or the like, or any combination thereof. In exemplary embodiments of the invention, the network may include one, or any number of the exemplary types of networks mentioned above operating as a stand-alone network or in cooperation with each other. Use of the term network herein is not intended to limit the network to a single network.

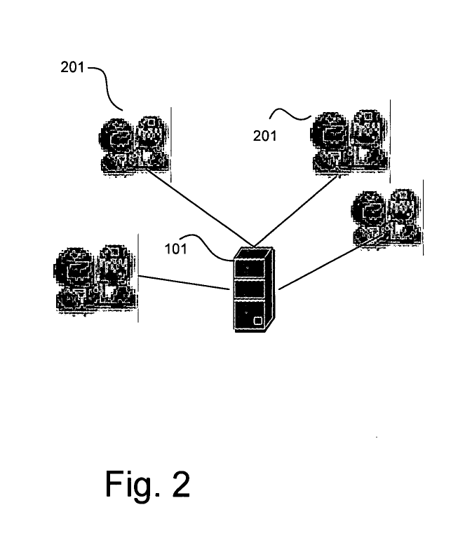

Alternatively, the record management system 102 may be created so that it is substantially contained within one or more customer's internal network in a self-hosting environment. Turning now to FIG. 2, a record management system 102 is shown in a self-hosting mode. The record management system 102 according to this embodiment may be substantially located so that it is in communication with the customer's internal network, and may or may not be accessible to users 201 outside of the customer's internal network. In this alternate embodiment, the record management system 102 may be associated with one customer, and the one customer may be responsible both for creating and updating the information contained in the record management system 102 and for maintenance to the record management system 102.

The record management system 102 may be used by the one or more customers in different ways as well. For example, the record management system 102 may be used to manage and operate the customer's storage facilities. In this mode, the record management system 102 may be used as a warehouse inventory system. One or more mobile devices, as explained more fully below, may be used to create an inventory from items, track the items throughout their creation, movement, and disposition, and receive new items and deliver items. Authorized users may be able to access the information regarding the warehouse inventory record management system 102 via a network. Access to the warehouse inventory record management system 102 may be restricted to authorized users. The record management system 102 may be used to collect and store information regarding one or more warehouses of inventory, and may support warehouse inventory in more than one time zone. The record management system 102 may also support an unlimited number of clients. The record management system 102 in this records center mode may support records regarding inventory items.

Alternatively, the record management system 102 may be used by the one or more customers in a corporate mode. In a corporate mode, the customers may use the record management system 102 to manage records of items owned by an individual business. The individual business may be, for example, an insurance company, a law firm, a hospital, or a government center. The individual business may wish to keep track of certain items, such as one or more types of documents. Individual business units may be configured within the record management system 102, and the individual business units may correspond to the individual business's divisions, departments, or any other subdivision of the individual business. Entities and sub-entities may be used within the record management system 102 to denote clients, matters, patients, or other individualized units which the individual business wishes to track. The record management system 102 in corporate mode may be used in both a multi-tenant and a self-hosting environment.

The management console may provide a centralized interface to configure and maintain the record management system 102. The management console may provide an interface to individual services used to configure and maintain the record management system 102. Access to the management console may be restricted to administrators of the management console, or to designees of the administrator or administrators. Alternatively, the individual services may have different access levels, so that individual users who may not be administrators of the record management system 102 may have access to one or more of the services. The management console may allow access to change or configure security parameters, business unit definition and information, item layouts and properties, location definition and information, services, holiday definition and information, retention schedules and items affected, item definitions and information, and record type definitions and information.

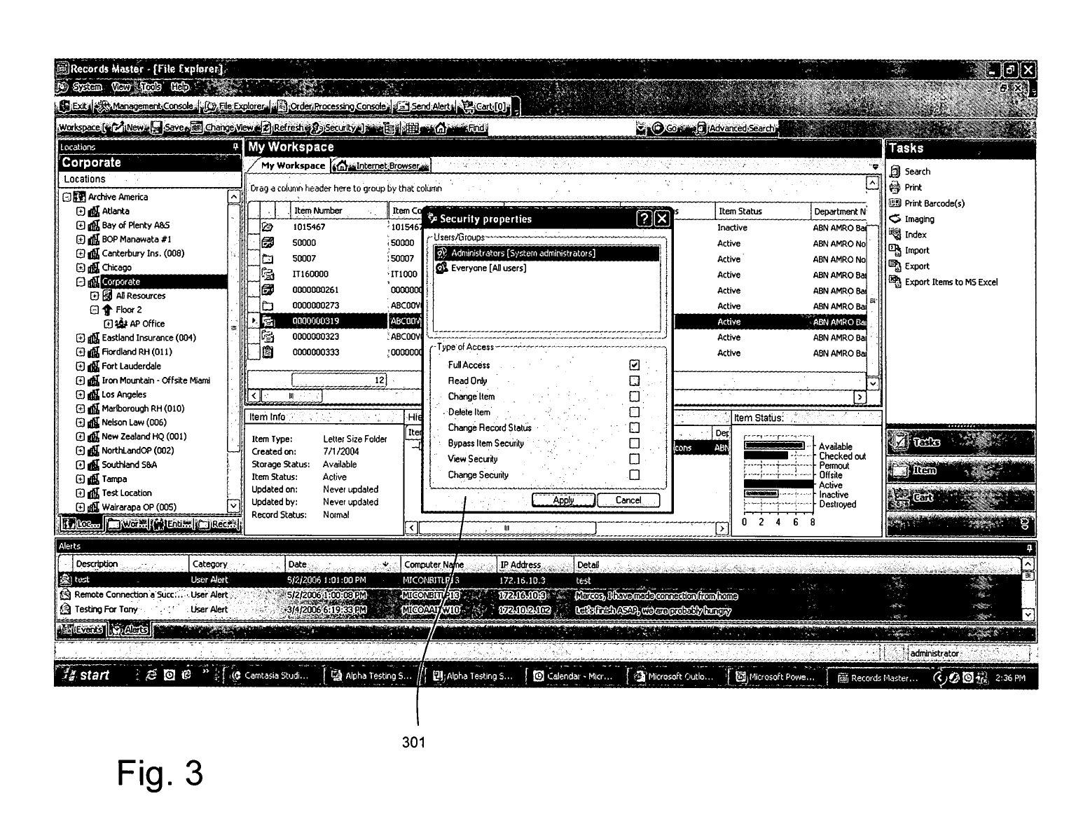

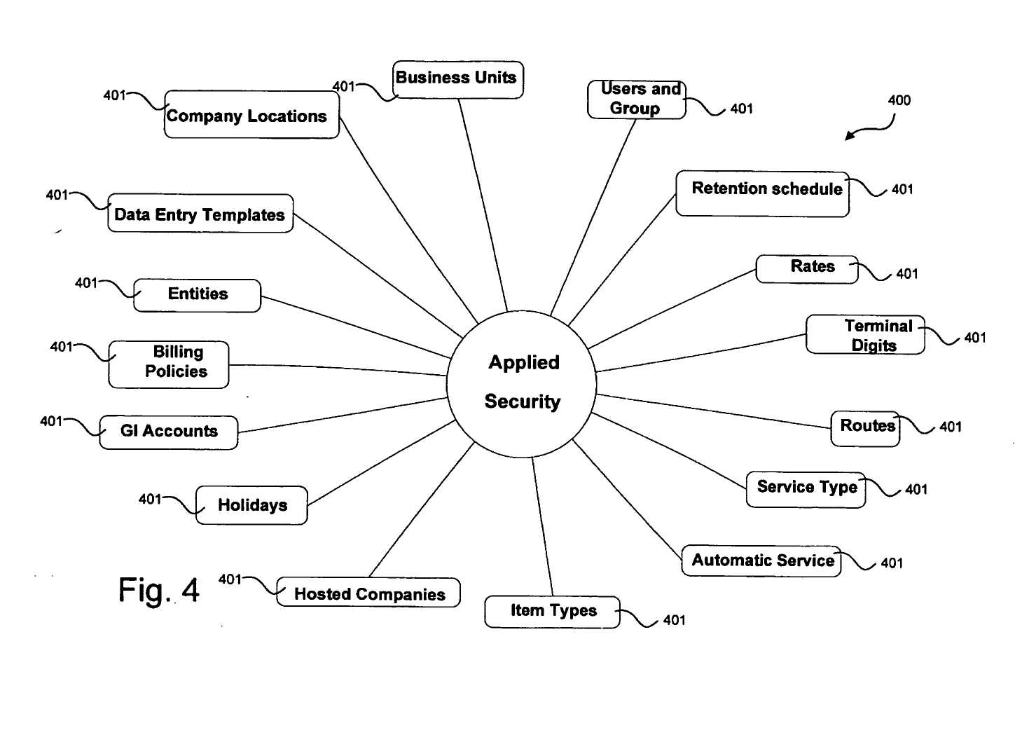

Turning now to FIG. 3, a screen showing the security properties of an item is shown. The security module may generally contain the rights for each user of the record management system 102. The rights may define what information the user has a right to view or create or modify or delete. All interaction with the system may be controlled by the security module. However, a user may be able to bypass the normal security, if allowed by the administrator. The user may use a security bypass which may allow the user to view, create, modify, or delete some or all of the information contained in the record management system 102. The owners of the data may be notified of the security bypass, and the bypass may be noted in a security log, or other electronic or paper file. The notification of the security bypass may be electronic (i.e., an e-mail to the owner, or a message through the record management system 102 to the owner), or the record management system 102 may print a paper record of the bypass for the owner. In an alternate embodiment, the user may create a security bypass request by attempting to access data not within the user's group of rights, and the security bypass request may be transmitted to the owner, who may approve or disapprove the security bypass request. If the owner approves the security bypass request, the user may access the data, and if the owner disapproves the security bypass request, the user may not access the data. The security bypass request or the approval or disapproval may be noted in a security log or other electronic or paper file. Turning now to FIG. 4, an exemplary diagram 400 is shown depicting possible security features (collectively, 401).

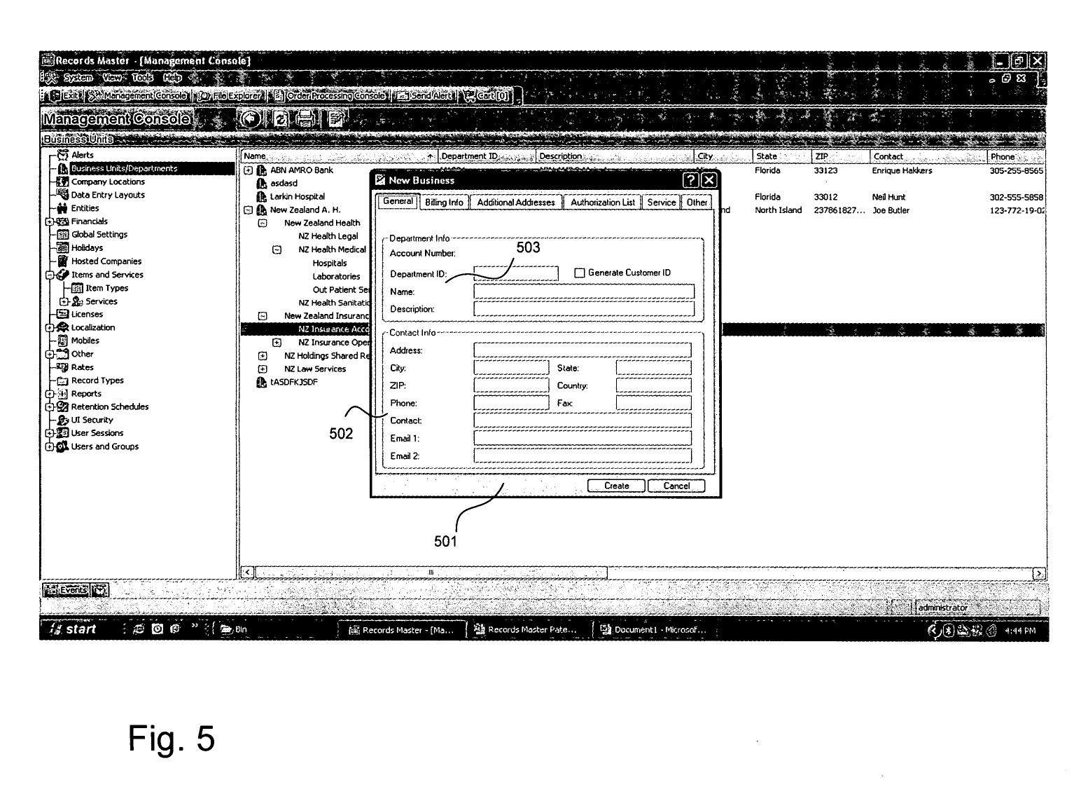

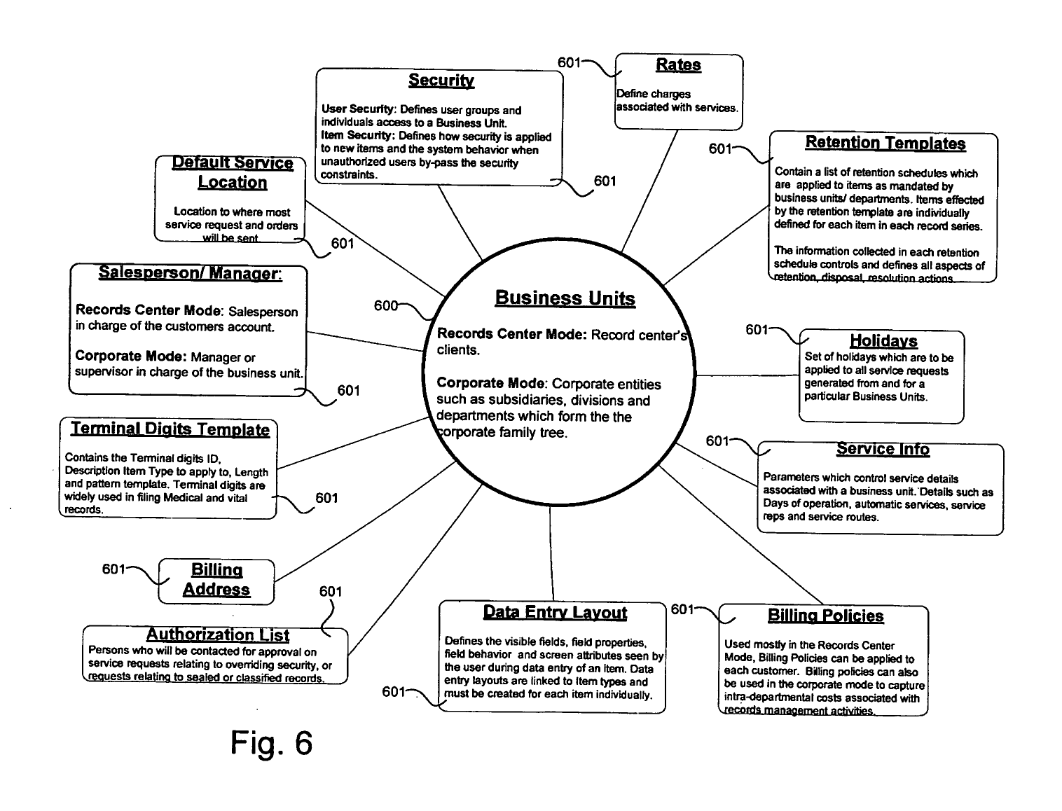

Business or department units may divide the customer or the customer's business into smaller pieces. Turning now to FIG. 5, an input screen 501 showing possible inputs for a new business unit is shown according to one embodiment of the invention. The input screen may contain, for example, contact information 502, a business unit name 503, and additional billing information. If the record management system 102 is configured in a records center mode, the record management system 102 may use business units to define, for example, a single client or a single patient. If the record management system 102 is configured in a corporate mode, then the record management system 102 may use business units to define the customer's business. For example, if the customer has three subsidiaries, or three divisions, or three departments, then a business unit may define one subsidiary, or one division, or one department. A security profile may be defined for all business units at once, and then inherited by each business unit individually, or a security profile may be created and maintained for each business unit individually. Within each business unit, a potentially infinite number of sub-business units may be created. Each sub-business unit may have an inherited security profile from the parent business unit, or each sub-business unit may have its own security profile. Item codes may also be assigned to each individual business unit or sub-business unit. Turning now to FIG. 6, a sample business unit 600 and elements comprising the business unit (collectively, 601) are shown according to one embodiment of the invention.

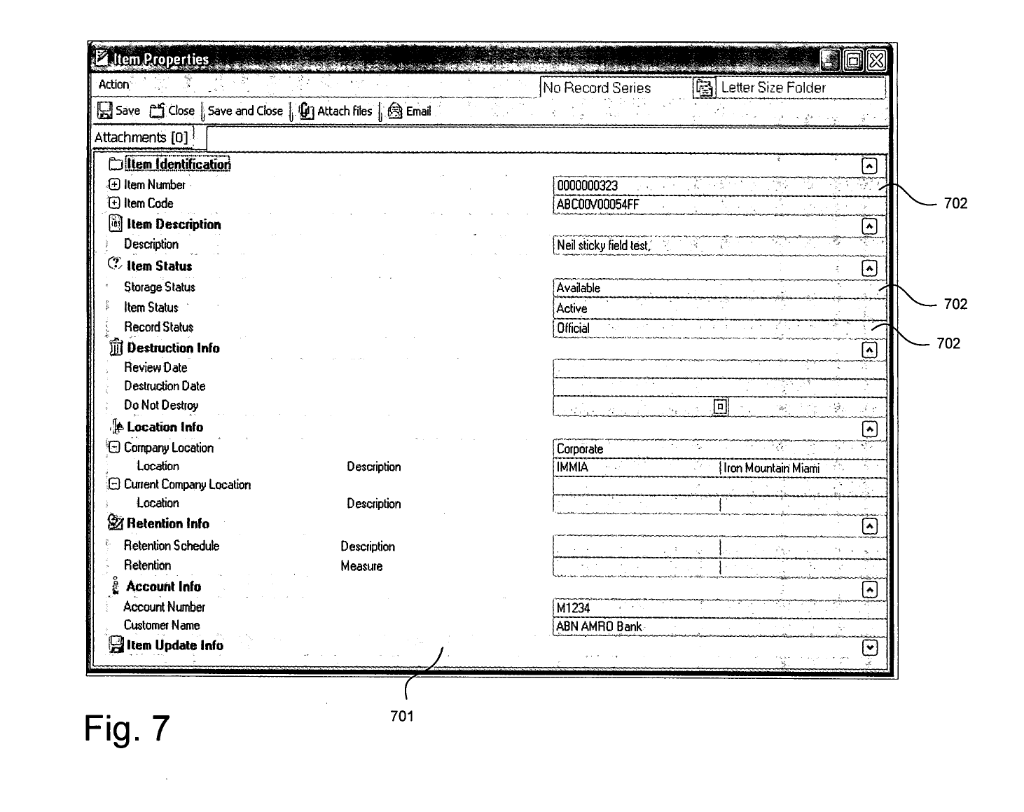

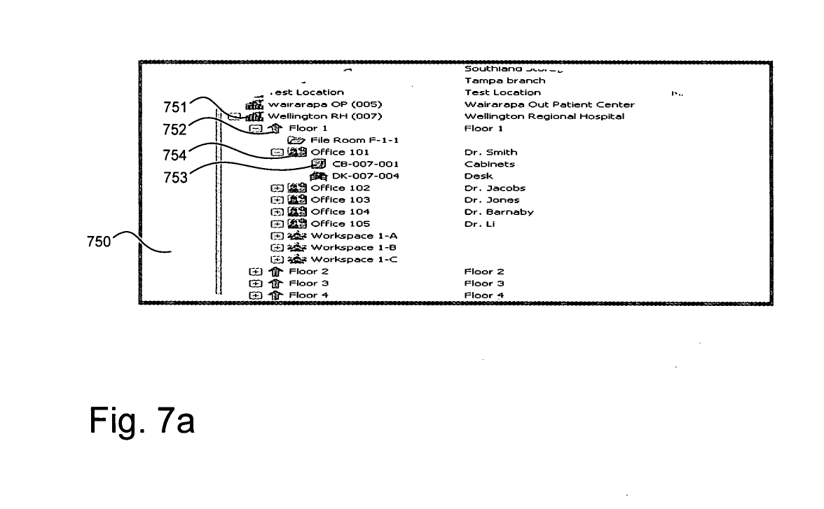

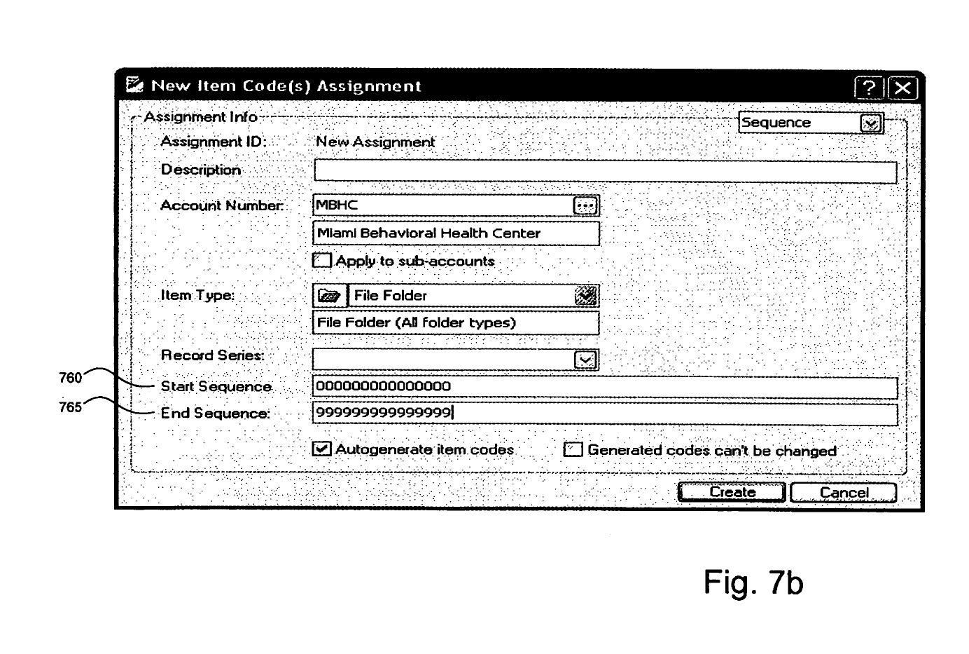

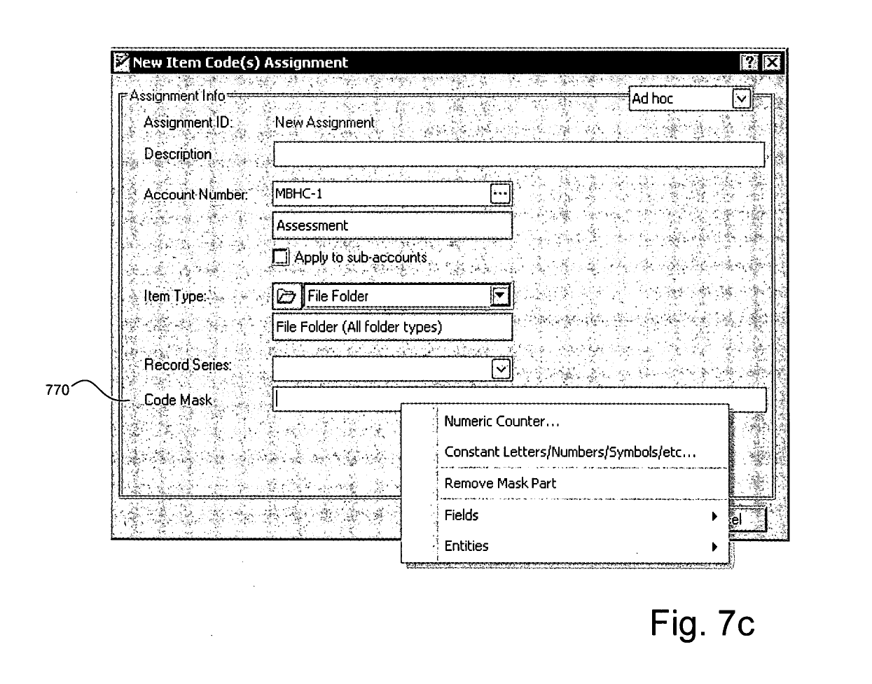

Each business unit or sub-business unit may have associated one or more items. Each of the one or more items may have a custom data entry template. Turning now to FIG. 7, a sample custom data entry template 701 for a type of item is shown according to an embodiment of the invention. The data entry template 701 may contain one or more fields 702, used to define and describe the item. More or fewer fields 702, or fields 702 of differing type, may be implemented according to the needs of the user. For example, an item type for patient background information may have a data entry template displaying fields for patient age, patient height, patient weight, and any other fields necessary or desired to gather information about the patient's background. An item type for patient billing information may have a data entry template displaying fields for insurance carrier, insurance identification number, and insurance billing address, and any other fields 702 necessary or desired to gather information about the patient's insurance coverage. The data entry template associated with an item may display fields 702 so that, for example, the order of data entered follows a logical progression (i.e., name, then address, then city, then state, then zip code).

To streamline and standardize data entry, one or more of the fields 702 may consist of one or more pre-determined choices. The administrator or the owner of the business unit, or a designee, may create the pre-determined choices, which may be chosen by the data entry user. Further, the administrator or the owner of the business unit, or a designee, may define one or more of the fields 702 as mandatory, so that a data entry user must enter data into the one or more mandatory fields 702 before the entry will be completed. The administrator or the owner of the business unit, or a designee, may also define one or more of the fields 702 as read-only so that data is entered automatically into the field 702, and the field 702 may not be able to be modified by the data entry user. Items created with a read-only field 702 may contain the text of the read-only field 702, as the data entry user may not be able to modify the read-only field 702. The administrator or the owner of the business unit, or a designee, may also create a field 702 that carries over data from one entered item to the next. For example, if one item was created by a data entry user and a field 702 called “Confidential?” was marked as “yes,” then when the item was complete and the data entry user caused a new item to be created, the “Confidential?” may already be populated with a “yes” answer. The data entry user may be able to freely modify the answer to “no,” and then the next item to be created may have a “Confidential?” field 702 already populated with a “no” answer. The data entry layouts may also have the ability to display electronic attachments within the layout. For example, a space may be provided on the data entry layout. When an electronic picture format is attached to the layout, the picture may display within the space. The item may also be associated with an identifier. The identifier may be unique for each item. The identifier may be attached to a physical record. For example, a label with a bar code may be attached to a physical record. The bar code may be unique within the record management system 102 so that the physical record is identified by the bar code. The identifier may be, for example, a unique numeric, alphanumeric, or symbol code, a one-dimensional or two-dimensional bar code, a radio frequency identification (“RFID”) tag, or any other identifier as known in the art.

Identifiers may be assigned to a specific item type or a specific department, a combination of the two, or may be assigned in any way convenient to allocate identifiers. If, for example, identifiers are assigned based on departments in the record management system, then child departments may inherit the identifier assignments based on the child's parent department. In an alternate embodiment, the child department may have its own identifier assignment, separate from the identifier assignment of the child's parent department.

Identifiers, such as bar codes, may be created in a sequential format or an ad-hoc format. In a sequential format, and shown in FIG. 7b, the identifiers may be created via the input of a start sequence identifier 760 and an end sequence identifier 765. For example, if the start sequence identifier 760 is specified as “00000,” and the end sequence identifier 765 is specified as “99999,” then the first identifier generated by the record management system for the series may be “00000,” the second identifier may be “00001,” the third identifier may be “00002,” and so on until reaching the end sequence identifier 765 of “99999.” In an ad-hoc format, an identifier may be created using unique metadata within an item. Shown in FIG. 7c, a code mask field 770 for an ad-hoc identifier may be created using fields from a record type. For example, if a patent record contained a record identifier number of “12345,” and the record management systems' users' user ID was smithj, then an ad-hoc identifier may be “12345-smithj-F00001.” A status identifier may thus include portions of metadata so that the identifier may be easily discerned. For example, a status identifier of “12345-smithj-F000001” may quickly indicate the patient's identification number and the person performing or reporting a test.

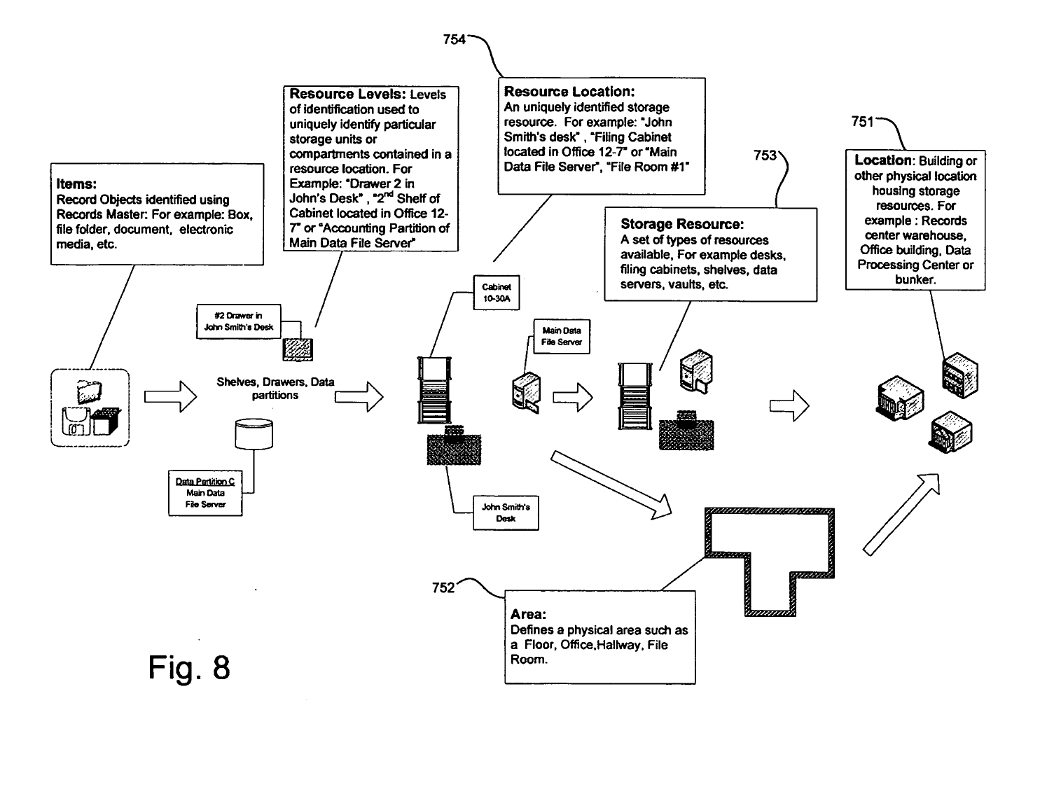

The record management system 102 may have a location field for each item contained within the record management system 102. Turning now to FIG. 7a, an exemplary screen 750 showing locations is provided according to one embodiment of the invention. The record management system 102 may have four properties for the location of each item. Turning now to FIG. 8, a diagram of one possible layout for item location is shown according to one embodiment of the invention. The four properties may be location 751, storage resource 753, area 752, and storage location 754. The location 751 property may be the broad physical area. For example, the location 751 property for an item in a large corporation may be “building 5,” denoting that the item may be found within the building which has been previously labeled or referred to as “5.” The location 751 property for an item may also be “warehouse,” if the company is small and does not have many buildings, or only has one building referred to as “warehouse.” The area 752 property may further define the location. For example, the area 752 property may be “2nd floor,” if the building identified in the location 751 field may have more than one floor. The area 752 property may also refer to a specific room, such as a server room or other identified room, such as “Room 212” The storage resource 753 property may define a list of storage areas. For example, some storage resource 753 property types may include “desk,” “filing cabinet,” “server computers,” or “shelves.” The storage location 754 property may define the specific instance of one of the storage resources 753 to narrow the location of the item. For example, the storage location 754 may be “the desk in office 207,” or “shelf #32 of rack #5.” The item locations may be defined at several different levels of aggregation in order to facilitate the movement of groups of files within a storage container. For example, if “rack #5” was to be moved from “Room 212” to “Room 108,” the definition of the area 752 property field for the storage location field may be updated to reflect that the area 752 property field moved from “Room 212” to “Room 108.” All of the items that included “rack #5” may then be updated to include the information regarding the move of the items. If one or more mobile devices was used to input item locations, then the mobile device may be able to record the actual location of the storage area (i.e., through a Global Positioning System receiver or other location detection device).

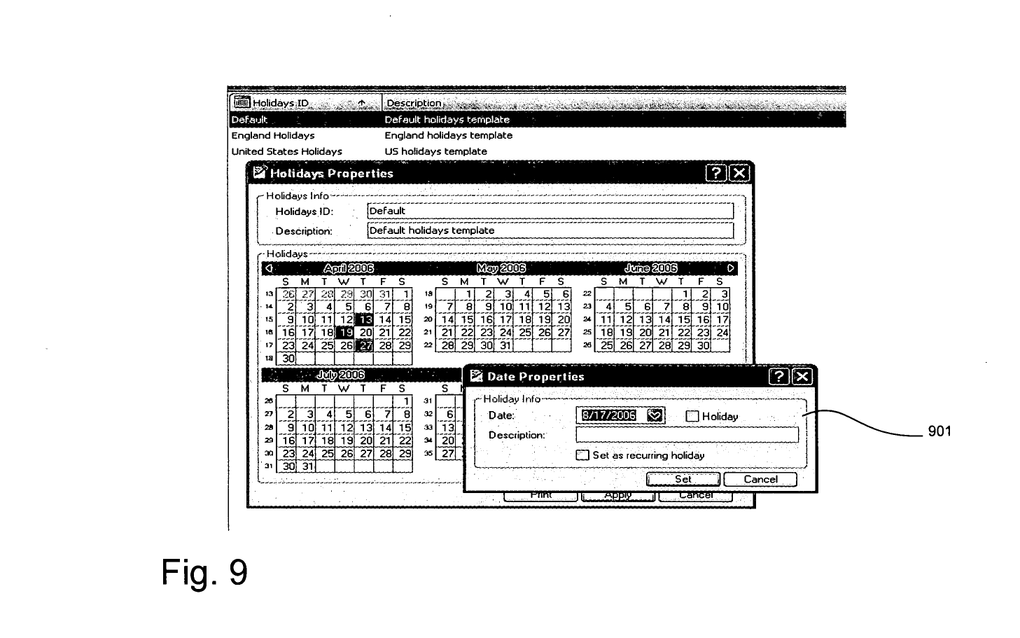

The record management system 102 may have the ability to support multiple time zones when viewing items. Turning now to FIG. 9, a screen 901 depicting holiday properties and date properties is shown according to one embodiment of the present invention. For example, a user in the US Eastern Standard Time Zone may create an item at 8:00 AM. A user in the US Pacific Standard Time Zone may see the creation time as 5:00 AM, the time in the Pacific Time Zone that the item was created. If an action is assigned a due date, the due date and time may be adjusted by the record management system 102 according to the user's specific time zone. Also, holiday templates may be created, defining dates and times for holidays. Holiday templates may be assigned to specific business units or departments. Holidays may be used by the record management system 102 to adjust due dates, so that they do not fall on a day set as a holiday, or they may be used to adjust other actions in the record management system 102. For example, if bills to clients were set to be printed on a day which was designated a holiday, the record management system 102 may move the action to an alternate date. Holidays may be created using screen 901, in which a date and a description of the holiday may be specified.

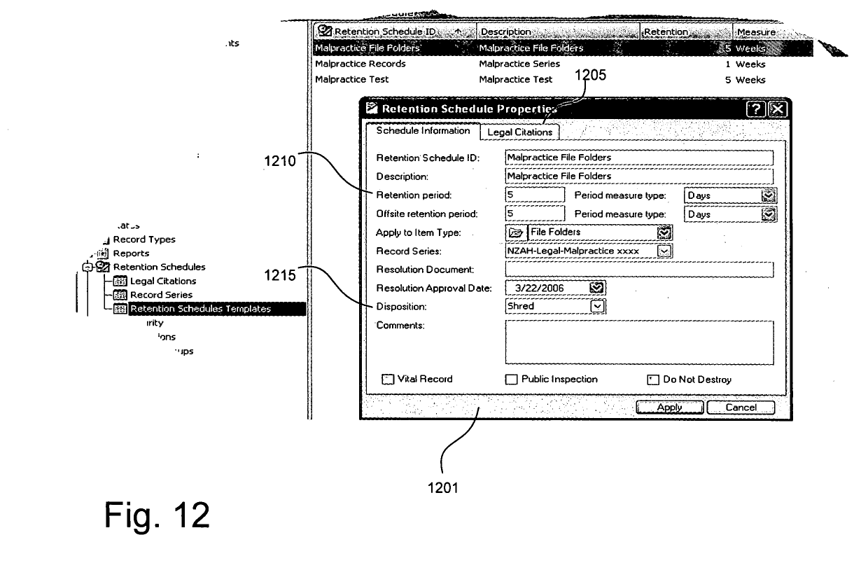

Retention schedules may be instructions allocated to item types to determine the length of time for which its items should be retained by the organization for business purposes, and the eventual fate of the items on completion of the retention time. Turning now to FIG. 12, an exemplary retention schedule 1201 is shown according to one embodiment of the invention. Retention schedules may be associated with a group of items, an item type or types, or an individual item. Retention schedules may also be associated with item series, which may be a group of related records used and filed as a unit. If the retention schedule describes the disposition of legal documents or documents that may be used in support of litigation, the retention schedule may be associated with one or more legal citations 1205 which set the guidelines for the retention schedule. The management console may link the citations and the item series to the retention schedule. A retention time 1210 may be provided, to specify a date on which the item should be destroyed. A destruction method 1215 may also be specified. On completion of the retention time, the retention schedule may, for example, state that the item is to be destroyed. If the item is electronic and it is within the capability of the record management system 102, the record management system 102 may delete the item automatically and may make a note in a log file. Or, the record management system 102 may create an action item or a “to do” list to delete an electronic item or to destroy a paper or tangible item.

A user may use a separate file explorer program to view, edit, create, or delete items. The file explorer may provide an interface to individual services used to view, edit, create, or delete items or properties. While access to the file explorer may be restricted to authorized users, the file explorer services may have a broader access than the services available to users of the management console. Alternatively, the individual services may have different access levels, so that individual users may have access to one or more of the services. The file explorer may allow users to view a customized workspace, view or modify entries in a cart system, create and view the status on items, search, and view and manipulate entities, locations, scanning and imaging tools, time zones and holidays, mobile devices, routes, retention schedules, and alerts.

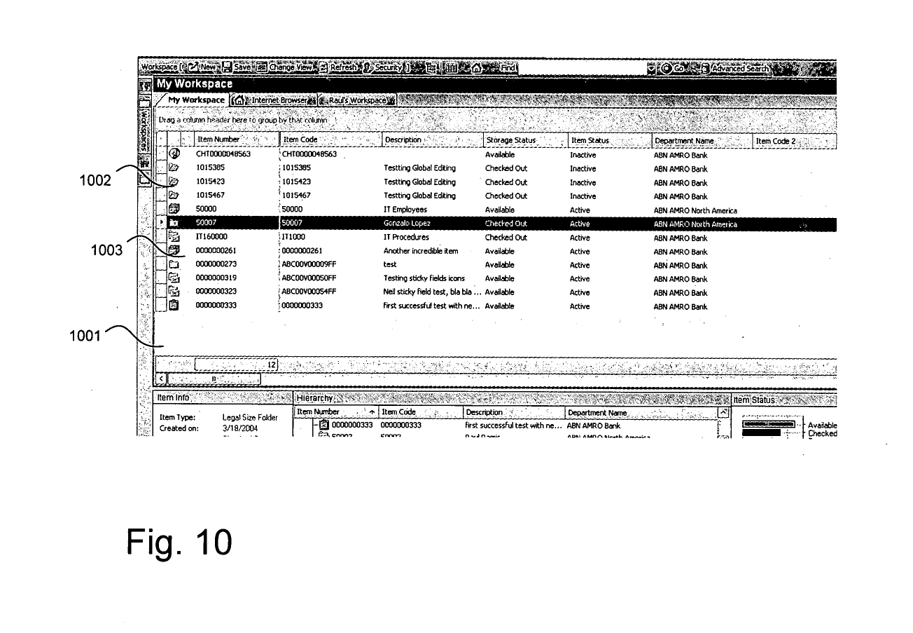

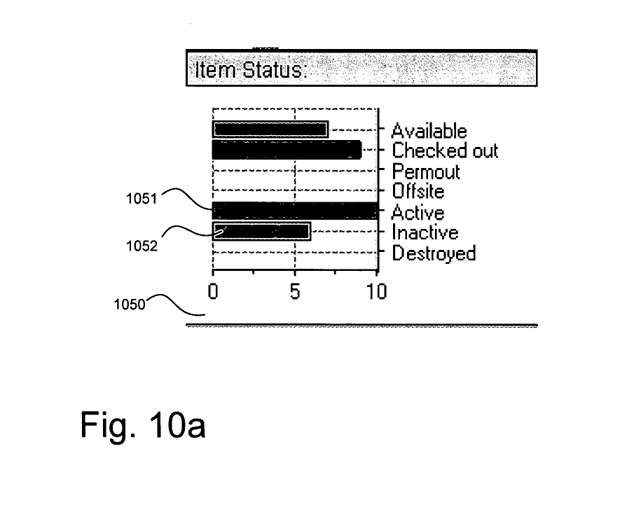

Turning now to FIG. 10, a sample workspace 1001 is depicted according to one embodiment of the invention. A workspace 1001 may be a list or a group of items that the user is currently working with. For example, the workspace 1001 of user X may show all of the items that user X has modified or viewed in the last day or week. Alternatively, the workspace 1001 may display items that the record management system 102 or other user has set for the user to complete. For example, the record management system 102 may show all items related to the monthly billing statements for a user who is in charge of modifying the monthly billing statements and mailing them to clients. In FIG. 10, the workspace 1001 is sorted by items that may be inactive 1002 and items that may be active 1003. One or more workspaces 1001 may be associated with a user. The workspaces 1001 may have either a table view or a card view. The table view may display items in a text-based, columnar format. The card view may display items in a pictorial format. The items may be moved on the workspace 1001 to the user's preference. The user may also set other preferences on the workspace 1001. For example, the user may specify a native language, for example English or Spanish. The workspace 1001 may display fields and/or values in the native language specified by the user's preferences. The workspace 1001 item locations may be saved with the workspace 1001 when the user exits the record management system 102 software program.

The workspace 1001 may also include a search criteria. For example, a user may define a workspace 1001 to automatically populate with all items belonging to a particular client, or to a particular patient or group of patients. When the user opens the workspace 1001, the record management system 102 may conduct a search of the items according to the preferences specified in the workspace 1001 properties and the workspace 1001 is populated with the appropriate items.

The workspace 1001 may have an interface consisting of one or more tabs, and the tabs may allow the user to view information not directly related to the record management system 102. For example, one of the tabs may allow access to the user's e-mail account, or one of the tabs may allow access to a web browser or similar program. In this way, the other functionalities of the user's computer may be accessible through the record management system 102 software, so that the user may not need to close the record management system 102 or run other software programs at the same time.

Each workspace 1001 may be secured by the user so that only the user may be able to access the workspace 1001. Each workspace 1001 may also be secured by the user so that other users or a group of other users may access the workspace 1001. The user may add security to an item via the workspace, and may designate an item so that security may be bypassed. If the user designates an item so that security may be bypassed, then the user may receive notification if a bypass occurs.

The record management system 102 may include a method for submitting items to be processed. The method may take the form of a cart and checkout system. For example, a user may create an item relating to a billing record for a patient, and may submit the item to the cart for processing by the accounting department. Or, the item may require the approval of the user's supervisor or manager before, for instance, it is deleted or modified. The user may select the item and then move it onto the cart icon, or may use a mouse or similar pointing device to click and drag the item from the workspace onto the cart icon. The user may select the cart icon to view the contents of the cart. The user may select the cart icon by double clicking the icon with a mouse or similar pointing device, or by using a keyboard shortcut. The user may submit all or some of the items within the cart for further processing, or may move one or more of the items within the cart to the workspace, so that no action may be taken on the moved items. When the user selects an item on the workspace, the record management system 102 may suggest appropriate services that may be available to the item. For example, if a user selects a billing record, appropriate services might be displayed to release the billing record to accounting, to release the billing record to the printer, or to release or send the billing record to the appropriate client. The user may select one or more of the suggested services, instead of looking through an array of services, only some of which may be applicable to or appropriate for the item. When a user has submitted an item or items from the cart for further processing, the user may be able to see the status of each of the items, so that the user may track the item or items through the process. The user may also communicate with the person or persons who may be selected to process the item after the user releases the item in the cart. The user may communicate with the person or persons in order, for example, to communicate information about the item or to request a status report on the progress of the item.

A file in accessible memory in the user's computer may be entered as an item into the record management system 102. Files which may be attached to an item may be saved in a file repository. A file repository may be a separate system in communication with the record management system 102. Alternatively, the file repository may be included within the record management system 102. Attachments may be processed by the record management system 102 to determine the text in the attachments; the text may be searchable by the record management system 102. An item status graph 1050 may also be provided on the workspace 1001. Turning now to FIG. 10a, an exemplary item status graph 1050 is provided according to one embodiment of the invention. An item status graph 1050 may show the quantity of items associated with different status levels. The graph 1050 may change dynamically when the status of items changes. For example, the number of active items on the workspace 1001 may be shown as a bar 1051 on the item status graph 1050, and the number of inactive items on the workspace 1001 may be shown as a bar 1052 on the item status graph 1050. If an item on the workspace 1001 were to be transferred to another person, or to be inactivated, then the bar denoting the active items on the workspace 1001 may decrease, reflecting the status change of the item.

Searching functionality on the workspace 1001 may be enhanced by using one or more integrated modules. Examples of integrated modules may be: entity view, location view, workspace view, and record view. Entity view may be a search conducted returning all items that may be associated with an entity or sub-entity. For example, entity view may be used to find all items associated with a specific client, or a specific patient. Location view may be a search conducted returning all items that may be associated with a storage location. For example, location view may be used to find all items associated with a specific room at a location, or a specific file cabinet. Workspace 1001 view may be a search conducted returning all items currently on a user's workspace 1001. Items may be viewed by selecting a workspace 1001 to display. Record view may be a search conducted to find a specific type or types of records. For example, record view may be used to find all items of the type “patient record.”

An entity may be a user-defined object. The record management system 102 may support an unlimited number of entities, and an unlimited number of sub-entities associated with an entity. An example of an entity may be a specific client. A business may have records regarding multiple clients, and each client may be a separate entity. The ability to create an unlimited number of entities and sub-entities may create the ability to model any hierarchy required to logically organize records within the business. Security may be assigned to an entity. Items or sub-entities associated with the entity may be automatically imputed with the security assigned to the parent entity. For example, if the security profile for a parent entity was set so that user X had no access to the entity, then user X may also have no access to all sub-entities or items associated with the parent entity.

The search tool may be used to search for items, entities, locations, or any other input within the record management system 102. The record management system 102 may have the ability to search within the files in the file repository in a full-text search mode, as well as the ability to search the item and entity properties. The search tool may also be used to formulate complex searches that may include multiple item or entity properties or also include full-text search terms. The search tool may also have the ability to utilize SQL search terms and constructions to initiate a search.

Paper or electronic documents may be associated with items. If a document is in a paper form, it may be scanned into an electronic form using a scanner, as is known in the art. The scanner may be operable to create an electronic file containing a likeness of the paper document. The record management system 102 may be operable to read the electronic file and apply optical character recognition (“OCR”) to the electronic file to convert the electronic picture of the document into computer-readable text. The OCR may include the ability to convert printed computer text into computer-readable text, or may include the ability to convert handwritten text into computer-readable text, or the ability to convert other marks made on paper into computer-readable text. The record management system 102 may also be operable to OCR the electronic likeness of the paper document and use the computer-readable text to populate specific fields of an item with text from the document. For example, a paper document may contain the word “CONFIDENTIAL” in the upper left corner of every page. The paper document may be introduced into a scanner, which may create an electronic file containing a likeness of the document. The record management system 102 may be able to use OCR principals to convert the electronic document into computer-readable text, read the word “CONFIDENTIAL” from the pages and note the position of the word within the document, and populate a field called “secrecy” in the item to which the electronic document is attached. The record management system 102 may complete this task without further human intervention. The record management system 102 may also OCR the entire document and associate the computer-readable text with the electronic file of the paper document, or may delete the electronic file of the paper document.

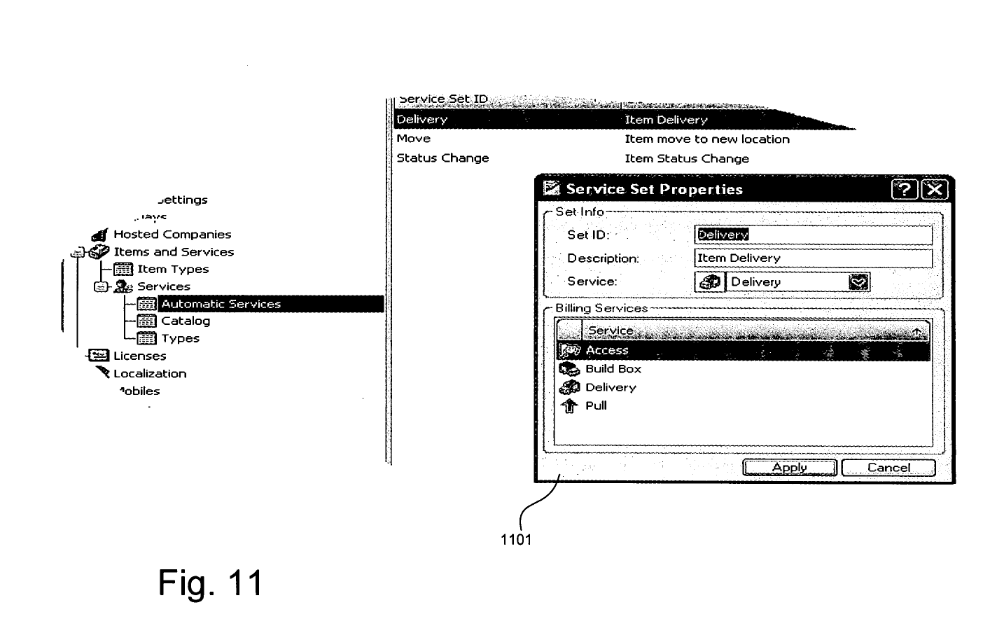

Turning now to FIG. 11, a list of potential services operable on the items may be provided to the user. Services may be applied to an order. The services may be provided to the user in the form of a catalog of services. The user may choose services from the catalog to apply to one or more items. The record management system 102 may also have groups of services shown in screen 1101, which services which require prerequisites or a group of services that require more than one service to complete. For example, an automatic service named “Delivery” may be comprised of smaller services called “Access,” “Build Box,” “Delivery,” and “Pull.” These smaller services may need to be performed in a specific order to fulfill the “Delivery” service.

One or more mobile devices may be used to view and/or input information into the record management system 102. A mobile device may include one or more input devices, and one or more output devices. The one or more input devices may include, for example, a keyboard operable to manually input data, or a bar code reader operable to scan a bar code for data encoded on the bar code, or a RFID tag reader operable to gather input from the data encoded in one or more RFID tags. The one or more output devices may include, for example, a display screen, a touch-sensitive display screen, a printer, or a speaker operable to create noises.

The mobile devices may be in wired or wireless connection with the record management system 102. For example, the mobile devices may communicate with the record management system 102 across a wireless network. The mobile devices may be in communication with the record management system 102 using standard network protocols, such as Internet Protocol (“IP”) or Transmission Control Protocol (“TCP”), or may use non-standard network protocols to communicate with the record management system 102. The mobile devices may also have the ability to work without communicating with the record management system 102 for periods of time. For example, the mobile devices may interface with the record management system 102 once to receive an update, and then may be deployed. The mobile devices may process items or view items or create new items during the deployment. The mobile device may then be in communication with a network, and send updates to the record management system 102. This process may occur at varying frequency. For example, the mobile device may be functional to operate independently and receive and transmit updates to the record management system 102 every minute, every hour, every day, or every week, or any other scheduled or unscheduled period. Further, the updates between the mobile devices and the record management system 102 may be automatic or manual. For example, the communication of data to the mobile device from the record management system 102 and vice versa may be initiated by the user of the mobile devices or may be initiated according to a schedule. The mobile device may also store the data surrounding the items in a non-volatile memory, such as a magnetic disk or flash memory data storage, so that a power loss may not permanently delete the data stored but not yet transmitted to the record management system 102. Additionally, each of the one or more mobile devices may display a different language. The menu system or input for the mobile device may allow different languages to be used. For example, one mobile device may allow a user to interact with it in English, while another mobile device may allow a user to interact with it in French. The selection of language may be changed on the mobile device, so that a user may work with any of the one or more mobile devices in a language most comfortable to them. Other adaptations may also be made to accommodate different cultures. For example, weight measurements could be input or converted into different standards (i.e., the weight or length of a package could be input in kilograms or centimeters, and translated to pounds or inches for inclusion into the record management system 102, or if items are stored in the record management system 102 in English units, they may be automatically converted into SI units for display if a user prefers). Additionally, the format of data may be changed according to the user. Some users may prefer a date in the layout “MONTH-DAY-YEAR,” while others may prefer “DAY-MONTH-YEAR.” The record management system 102 may display units and other dates and times according to the wishes of the user.

The mobile device may also include a printer for printing identifiers to place on or with physical records. For example, a mobile device may be used to create a new item, and associate an existing paper document with the item. The mobile device may then use a printer to create a bar code label to affix to a document.

The mobile device may include support for one or more electronic pick lists. A pick list may be a list from which a user may select one or more items. Pick lists may be generated by the record management system 102 and transmitted to the one or more mobile devices, or may be created by the one or more mobile devices and transmitted to the record management system 102. The one or more mobile devices may support pick lists. The one or more mobile devices may also have the ability to scan one or more identifiers attached to a physical record. A second or subsequent identifier may include data relating to a pick list. The one or more mobile devices may be operable to receive one or more pick lists from the document management system. The mobile devices may also be operable to scan or input data concerning one or more physical records relating to the one or more pick lists. Finally, the mobile devices may be operable to transmit partially completed, completed, or uncompleted pick lists to the record management system 102. For example, the document management system may create an inventory pick list containing the identifiers for physical records A, B, and C, which may be identified by unique bar codes. The user may take a mobile device and may receive the information in the pick list from the record management system 102. The user may then scan the bar codes for records A, B, and C, which may be located on the physical files. The user or the mobile device may then transmit the completed pick list data to the record management system 102. The pick list order detail information may also be transmitted to the mobile device, if the user desires the detail information. The mobile device may also be operable to sort the one or more pick lists on any criteria, or sort the items indicated within the pick lists on any criteria.

The pick lists generated by the record management system 102 may include an instruction to move the physical record from one location to another location. The one or more mobile devices may be operable to transmit information to the record management system 102 indicating that the physical record has been moved from one location to another location. The user may accomplish this by indicating a physical record and a new location, for example by scanning a bar code attached to a physical record and then scanning a bar code attached to a location. Or, the pick list may define a temporary holding area for physical records, and then the physical record may be automatically indicated to have been moved to the temporary holding area when the physical record identifier is read into the mobile device.

If one or more users orders a service or an item, then the order information may be transmitted to the one or more mobile devices. The order information may be sorted according to any criteria on the mobile device. The mobile device may also be operable to enable the user to verify the orders before beginning the order services. The mobile device may be able to receive the order information, including information regarding the specific items in the order, and may be operable to scan some or all of the items delivered to ensure that all of the order items were received. The mobile device may also be operable, through the one or more input devices or through information transmitted from the record management system 102, to change services associated with an order. For example, if the order is to receive 10 items, and only 9 items were received, then the mobile device may be operable to change the original order to 9 items if that was the correct order amount, or may be operable to input a note with the order that only 9 items were received. The mobile device may also be operable to add or delete services associated with an order. For example, the mobile device may be operable to add a separate pickup date to a part of the order, or add a service to deliver the items if none was in the original order.

If the order is to pick up one or more items, then the mobile device may be operable to scan the one or more items and transmit the unique identifiers to the record management system 102, so that an appropriate audit trail may be kept regarding the location of the one or more items. A signature log may also be kept to ensure a proper audit trail, if the order or the item indicates that an audit trail be kept. For example, the order may require that the delivery agent obtain a signature from the recipient. The mobile device may be configured with a touch screen, so that an electronic signature may be received on the mobile device and transmitted to the record management system 102. Alternatively, a paper signature log may be kept, and the signatures may be associated with the order or the item. The user may complete the order using the one or more input devices associated with the mobile device, so that the completed status may be transmitted to the record management system 102. The mobile device may also be operable to send a message to the requester of the services when the services have been completed, or if a problem arises. For example, if an order was placed for 10 items and only 9 items arrived and were scanned with the mobile device, an e-mail may be sent to the requestor and the sender notifying them of the discrepancy between the order and the actual delivery.

If physical records or other items need to be refiled, then mobile devices may be used to accomplish refiling. The user may scan the item and then scan the new location to complete a “move” of the file from one location to another location. Bulk refiling of multiple items may also be accomplished without scanning each item and location (i.e., multiple items may be scanned, and then the new location may be input into the mobile device, and the mobile device may then transmit that information to the record management system 102). Additionally, a location may be audited. A user may input all of the items physically located in the location, and the mobile device may transmit that information to the record management system 102, where it may be compared against the list of items that were expected to be found in the location. The results may be stored or transmitted to the mobile device or transmitted to any other user of the record management system 102. The mobile device may also be operable to receive detailed information about one or more specific items which may be input into the mobile device. This operation may be restricted by the user's security settings. For example, if the user of the mobile device did not have access to a particular item, the record management system 102 would not allow detailed information to be transmitted to the user's mobile device if the user attempted to inquire about the physical record associated with the item.

If the mobile devices are used to receive items or goods, then the mobile devices may be operable to scan items into a temporary location (i.e., a warehouse or other holding location), until they can be distributed appropriately (i.e., to the second shelf of unit #423 in building 4B, room #234). Exceptions may be generated if necessary when the mobile device is synchronized with the record management system 102. Exceptions may be handled on the record management system 102 and may be pushed back, if necessary, to the mobile device. Specific activities may be generated for the incoming items, such as “Receive,” or “Add.” And new items may be analyzed for unique identifiers.

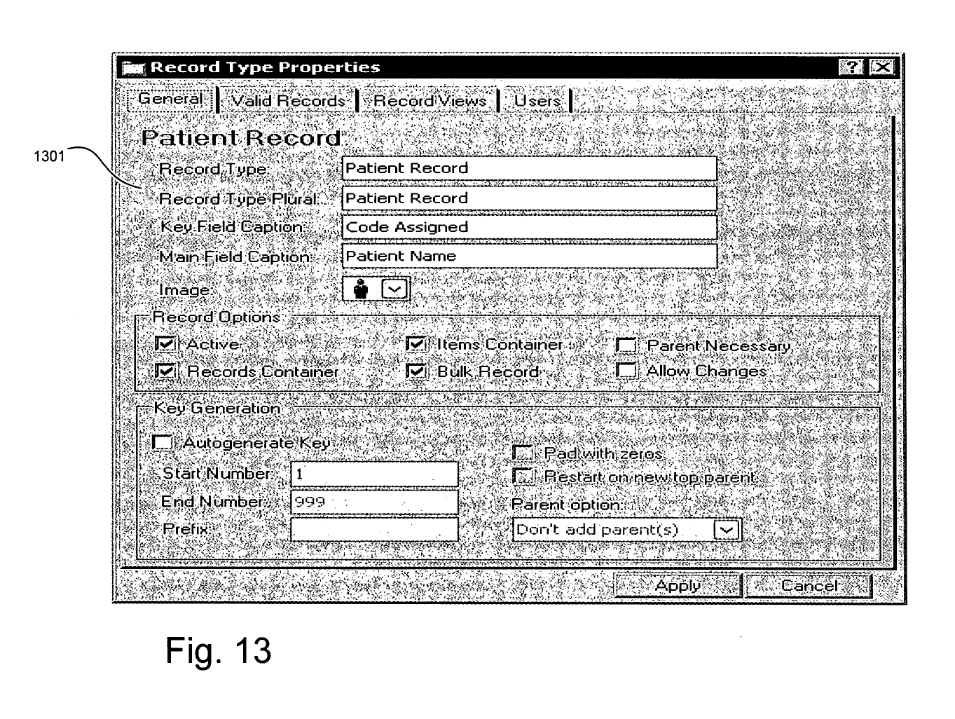

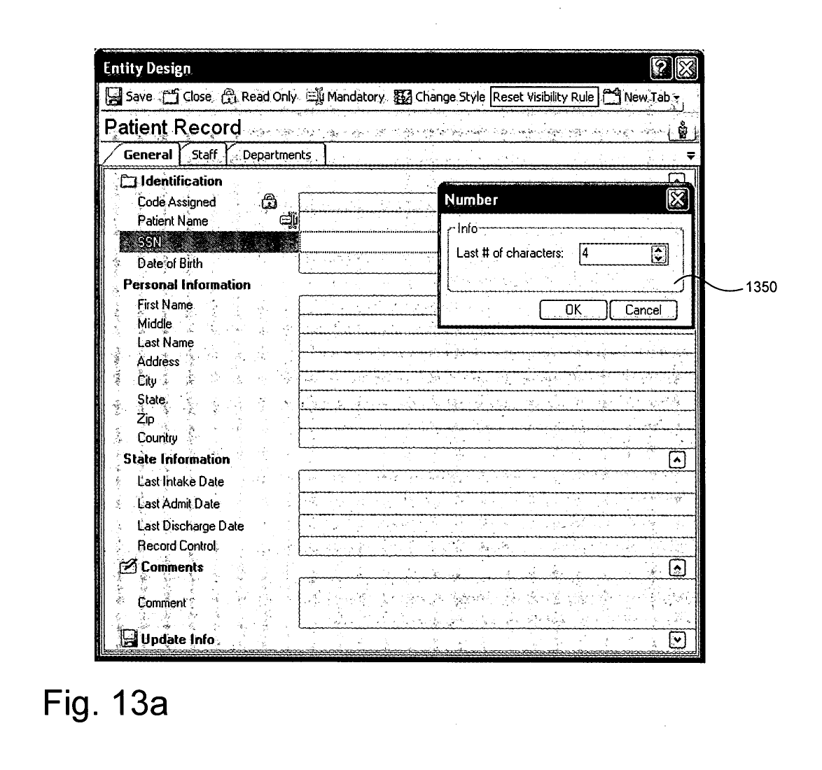

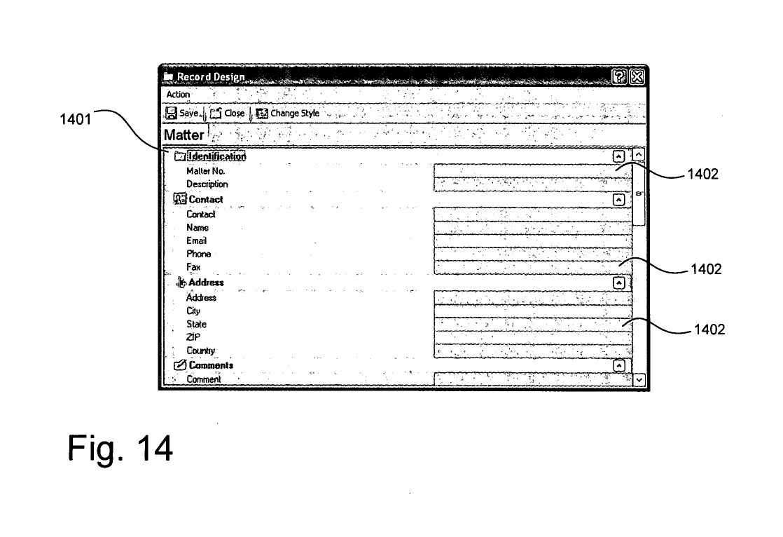

Turning now to FIGS. 13, 13a, and 14, the user may create a custom data entry template for each type of item in the record management system 102. A sample screen 1301 listing properties of the data entry template is shown in FIG. 13. A sample template design form 1401 is shown in FIG. 14. One or more fields 1402 may be used to create the template in the template design form 1401. The template design form 1401 may be used to order the layout of the fields 1402, or may be used to adapt the field 1402 layouts (i.e., change size or shape or position).

A record type may classify a set of related data elements into one or more collections or types. A record type may contain one or more data elements. Data elements defined in a record type may include, for example, elements such as name, street, or phone number. Data elements in a record type may also include embedded record types, so that a record type may include one or more other record types. The ability to embed a record type within another record type may allow for the creation of complex data structures. The record types may be attached to entities, and the user may define entities based on record type. Record types may be attached to entities.

One possible field property may obscure some or all of the data entered into a field. Shown in FIG. 13a, a visibility setting 1350, may be set so that some or all of the data in a field of a form 1401 may be obscured. For example, a field box for a Social Security Number may be created on a form 1401. The visibility setting 1350 for the particular field may be set so that only the last four digits of the Social Security Number are shown. This may limit the users of the record management system 102 who have access to especially sensitive information; a user may be able to read information pertinent to the user's job, for example a street address or telephone number, but may be denied complete access to highly sensitive information shown on a record, for example a Social Security Number.

Another possible field property may be the language of the fields. For example, a field may be named “Name” in English and “Nombre” in Spanish. Both values may be associated with the field, so that if a user specifies English as the native language, the field may display “Name,” and if a user specifies Spanish as the native language, the field may display “Nombre.”

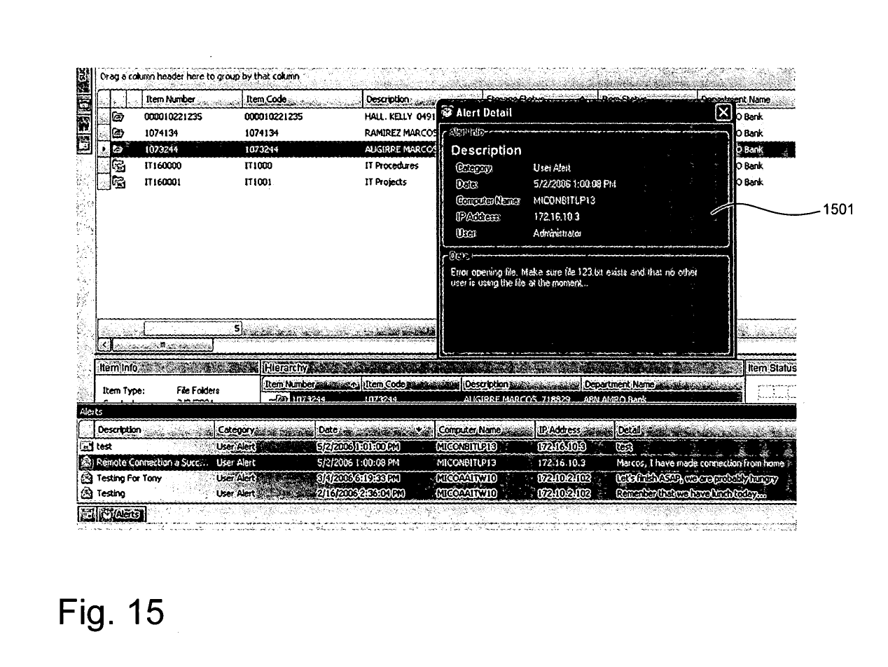

The record management system 102 may be configured to provide alerts to users. Turning now to FIG. 15, a sample alert 1501 is shown according to one embodiment of the invention. An alert may notify the user or an administrator of various errors or potential problems with the record management system 102. Users may subscribe to alerts regarding the record management system 102. For example, a user may subscribe to an alert that sends the user a message when another user attempts to access records that the user owns. Or, a user may subscribe to an alert to notify the user when an item has reached the end of its retention schedule and should be deleted or destroyed. Or, an administrator may subscribe to an alert notifying the administrator that a storage area is full or nearly full. The user may also specify the ability to receive an alert by different notification methods. For example, a user may wish to receive an alert by text message to their cellular telephone, or by e-mail, or by a pop-up window, or by an automated phone call or voice message, or by any other way of notification as practiced in the art. A user may receive different alerts through different notification methods.

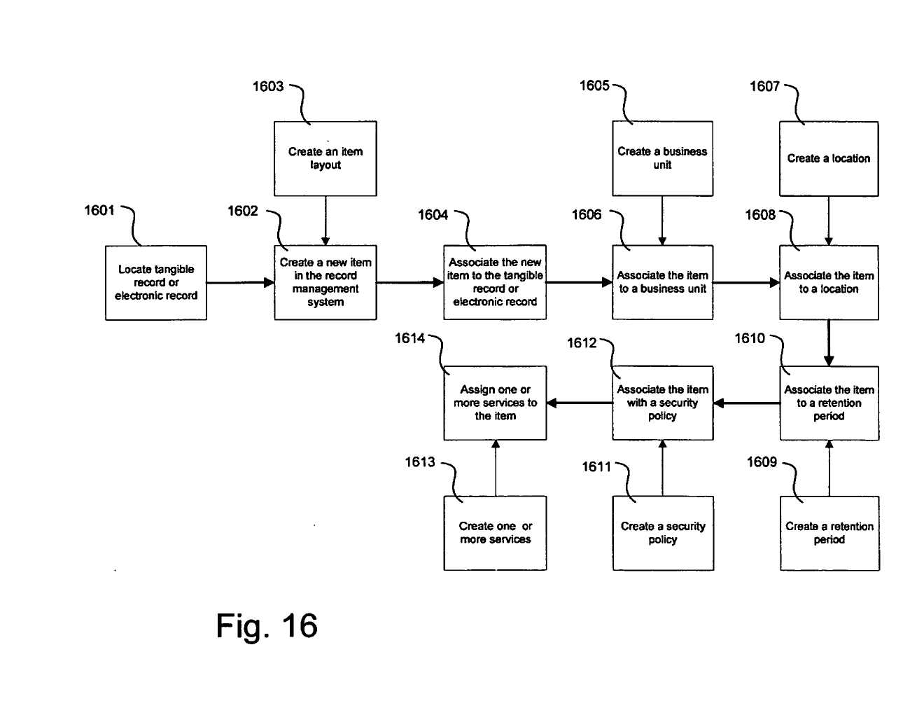

Turning now to FIG. 16, an exemplary flowchart of a record being associated with an item is shown. Starting at block 1601, a tangible record or an electronic record is located. The operator of the record management system may wish to create an item for this record in the record management system. In block 1602, the user may create a new item in the record management system. The user may use an item layout that has been previously created, or may create a new item layout for this record, as shown in block 1603. In block 1604, the user than associates the new item to the tangible record or electronic record. This association may occur by describing the record within the fields provided in the item. In block 1606, the user may associate the item to a business unit. The business unit may have been previously created, or the user may create a new business unit, as shown in block 1605. Next, the user may associate the item to a location, as shown in block 1608. The location fields may have been previously created; for example, if other records exist near the record for the new item, then the location may have already been created to associate with the existing items/record associations. Alternatively, and as shown in block 1607, the user may create a location to associate with the new item. In block 1610, the user may then associate the item with a retention policy or retention schedule. If no retention policy is created or suitable, a new retention policy may be created as shown in block 1609. Next, in block 1612, the user may associate the item with a security policy. The security policy may be inherited from the business unit previously assigned to the item, or a new security policy may be created as shown in block 1611. Finally, the user may assign one or more services to the item, as shown in block 1614. The user may assign as many services to the item as may be necessary or desirable, or may assign no services to the item. If a suitable service does not exist in the record management system, the user may create one or more services to associate with the item, as shown in block 1613.

The present invention encourages the efficient and organized storage of information regarding tangible and intangible records for a business. The business may use the record management system 102 to quickly locate tangible records and electronic record. The reduced location time for business records increases productivity and reduces the risk of adverse consequences for misplaced or inadvertently destroyed business records. The present invention also may also create a level of security surrounding important or confidential business records, making those types of records accessible only to authorized users.

The embodiments of the present inventions are not to be limited in scope by the specific embodiments described herein. For example, the record management system may only be used to store information regarding tangible records, or only be used to store information regarding electronic records. Or, one or more features discussed may not be implemented in a record management system. Thus, such modifications are intended to fall within the scope of the following appended claims. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A method for managing records, comprising:
associating one or more records with one or more items;
associating one or more services with the one or more items;
providing a virtual cart for the user to select one or more services for execution; and
selecting one or more relevant services related to the one or more items for the user to choose.

2. A method for managing records, comprising:
associating one or more records with one or more items;
associating one or more security profiles to each of the one or more items;
wherein the one or more security profiles operate to restrict access to each of the one or more items to authorized users; and
wherein the one or more security profiles may be bypassed by non-authorized users.

3. A method according to claim 2, further comprising creating an audit trail for the one or more security profile overrides.

4. A method for managing records, comprising:
associating one or more records with one or more items;
associating one or more services with the one or more items;
providing one or more workspaces, the one or more workspaces associated with one or more users;
associating one or more services with one or more workspaces; and
allowing the one or more users to sort the one or more items associated with the one or more workspaces according to the preference of the one or more users.

5. A method according to claim 4, further comprising providing one or more graphs to show the status of the one or more services associated with the one or more items.

6. A method for managing records, comprising:
associating one or more alerts to one or more services;
associating one or more records with one or more items;
associating the one or more services with the one or more items;
allowing one or more users to subscribe to one or more alerts; and
informing one or more users subscribed to one or more alerts on the status of the one or more services associated with the one or more alerts.

7. The method of claim 6 where informing the one or more users of an alert is selected from the group consisting of a cellular telephone, e-mail, a pop-up window, an automated phone call, or a voice message.

8. A record management system comprising:
a module to associate one or more records with one or more items;
a module to associate one or more services with the one or more items;
a module to provide a virtual cart for the user to select one or more services for execution; and
a module to select one or more relevant services related to the one or more items for the user to choose.

9. A record management system comprising:
a module to associate one or more records with one or more items;
a module to associate one or more security profiles to each of the one or more items;
wherein the one or more security profiles operate to restrict access to each of the one or more items to authorized users; and
wherein the one or more security profiles may be bypassed by non-authorized users.

10. A system according to claim 9, further comprising a module to create an audit trail for the one or more security profile overrides.

11. A record management system comprising:
a module to associate one or more records with one or more items;
a module to associate one or more services with the one or more items;
a module to provide one or more workspaces, the one or more workspaces associated with one or more users;
a module to associate one or more services with one or more workspaces; and
a module to allow the one or more users to sort the one or more items associated with the one or more workspaces according to the preference of the one or more users.

12. A system according to claim 11, further comprising a module to provide one or more graphs to show the status of the one or more services associated with the one or more items.

13. A record management system comprising:
a module to create one or more data entry templates associated with one or more item;
a module to associate one or more records with the one or more items; and
a module to use the one or more data entry templates to input data associated with the one or more records into the one or more items;
wherein the one or more data entry templates allows frequently used data to be pre-populated within the one or more items.

14. A record management system comprising:
a module to associate one or more alerts to one or more services;
a module to associate one or more records with one or more items;
a module to associate the one or more services with the one or more items;
a module to allow one or more users to subscribe to one or more alerts; and
a module to inform one or more users subscribed to one or more alerts on the status of the one or more services associated with the one or more alerts.

15. The system of claim 14 where informing the one or more users of an alert is selected from the group consisting of a cellular telephone, e-mail, a pop-up window, an automated phone call, or a voice message.

16. A method for managing records, comprising:
associating one or more records with one or more items, the one or more items further associated with one or more locations;
associating one or more services with the one or more items;
associating one or more locations with the one or more items;
providing one or more mobile devices;
wherein the one or more mobile devices are operable to create one or more records,
the one or more mobile devices are operable to view one or more of the one or more records and services,
the one or more mobile devices are operable to change the location associated with one or more of the one or more items, and
the one or more mobile devices are further operable to select one or more of the one or more services associated with the one or more items; and
providing one or more pick lists available to the one or more mobile devices,
wherein the one or more pick lists include one or more of the one or more services associated with the one or more items.

17. A system for managing records, comprising:
a module for associating one or more records with one or more items, the one or more items further associated with one or more locations;
a module for associating one or more services with the one or more items;
a module for associating one or more locations with the one or more items;
one or more mobile devices;
wherein the one or more mobile devices are operable to create one or more records,
the one or more mobile devices are operable to view one or more of the one or more records and services,
the one or more mobile devices are operable to change the location associated with one or more of the one or more items, and
the one or more mobile devices are further operable to select one or more of the one or more services associated with the one or more items; and
a module for providing one or more pick lists available to the one or more mobile devices,
wherein the one or more pick lists include one or more of the one or more services associated with the one or more items.
